(19) United States
(12) Patent Application Publication
(10) Pub. No.: US 2008/0241770 A1
(43) Pub. Date: Oct. 2, 2008

(54) TOPCOAT FOR INITIALIZING THERMALLY REWRITABLE MEDIA

(75) Inventor: Chauncey T. Mitchell, Lakeland, TN (US)

Correspondence Address: Stephen B. Salai, Esq.;Harter, Secrest & Emery LLP, 1600 Bausch & Lomb Place, Rochester, NY, 14604-2711, US

(73) Assignee: WS PACKAGING GROUP, INC., Algoma, WI (US)

(21) Appl. No.: 11/690,892

(22) Filed: Mar. 26, 2007

(51) Int. Cl. G03C 1/00; B32B 9/04

(52) U.S. Cl. 430/495.1; 428/411.1

(57) ABSTRACT

A thermally rewritable instrument, such as a card, tag, ticket, or label, includes a substrate and a thermosensitive optical recording medium on a front or back face of the substrate. A topcoat in the form of a high-temperature coating is applied over the thermosensitive optical recording medium to substantial advantage. For example, the disclosed topcoat enables the instrument to be thermally printed without producing speckle that would otherwise accompany such thermal printing prior to the thermosensitive optical recording medium being thermally erased. The topcoat as disclosed can also double or more the number of life cycles printing and erasing the underlying thermosensitive optical recording medium can undergo without significant loss of image density. In addition, the disclosed topcoat can be arranged to have an ink-repellant surface to deter the adherence of stray marks or graffiti over the front or back face of the instrument.

### TECHNICAL FIELD

The invention relates to rewritable media of the type that includes a reversible thermosensitive optical recording medium. The optical medium can be imaged, erased, and re-imaged in response to thermal inputs.

### BACKGROUND OF THE INVENTION

Thermosensitive rewritable technologies can be used to record information on their own or in conjunction with other recording technologies such as magnetic strips or RFID tags that require separate readers to extract information. The combination of optically readable thermally rewritable technologies with non-optical machine-readable recording technologies is particularly advantageous for cards, tags, tickets, labels, and other media that hold or access updatable information.

Prepaid cards, loyalty cards, passes, gaming machine tickets, shipping tags, and other instruments that are both machine readable and reference updatable information can benefit by the addition of a thermosensitive optical recording medium whereby the updatable information can be visibly displayed on the media. The visibly displayed information can be the same or different from the information that is otherwise recorded. For example, updatable information stored in a machine-readable (e.g., electronic or magnetic) form can be displayed by incorporating a thermosensitive optical recording medium on the same substrate. Alternatively, the machine-readable information can comprise an account number that accesses a remote database containing updatable information, and the thermosensitive optical recording medium can display updated information from the remote database.

Thermosensitive optical recording materials, also referred to as thermally rewritable or heat reversible recording materials, can be repetitively printed and erased by the controlled application of heat. Generally, such thermosensitive optical recording materials locally alternate between two equilibrium or quasi-equilibrium states upon reaching different temperature thresholds or undergoing different temperature transitions. For example, the thermosensitive optical recording materials can include a heat-sensitive layer that locally alternates between transparent and opaque (colored) in response to the application of different heat energies. Some thermosensitive materials, such as leuco dyes or low-molecular weight organic substances dispersed throughout a resin matrix, assume colored or uncolored states depending upon cooling rates. Other thermosensitive color-changing materials include thermochromic materials, such as thermochromic liquid crystal materials or solubilized dyes, microencapsulated dyes, or dyes mixed with a fusible solvent and fabricated in particulate form.

A period of break-in or at least a thermal cycle for erasing an image can be required to produce acceptable images. For example, the initial images produced in rewritable thermosensitive recording layers can be beset with unintended speckle. While the causes of the speckle are not entirely clear, new thermosensitive optical recording media is often not in acceptable condition for use until the media undergoes an additional thermal cycle such as required for erasing images in the thermosensitive recording layers.

### SUMMARY OF THE INVENTION

A topcoat can be applied to thermosensitive optical recording materials in accordance with the invention to initialize the thermosensitive optical recording materials for producing the intended images upon first use. The topcoat reduces speckle or other optical defects that would otherwise accompany the first printing of the thermosensitive optical recording materials. Applied, for example, as a high temperature silicone or varnish coating, the topcoat can also have the effect of extending the number of printing and erasing cycles (i.e., the number of life cycles) that can be completed within performance specifications. Protection against stray marks or graffiti can also be provided by the topcoat.

One version of the invention as a thermally rewritable instrument includes a substrate having front and back faces and a thermosensitive optical recording medium on one of the front and back faces. A high-temperature coating applied over the thermosensitive optical recording medium provides for thermally printing the instrument without producing speckle that would otherwise accompany such thermal printing prior to the thermosensitive optical recording medium being thermally erased.

The high-temperature coating, as preferably applied, treats an underlying unevenness to provide more uniform transfers of heat between a thermal print head and the thermosensitive optical recording medium. The high-temperature coating also preferably has an ink-repellant surface to deter the adherence of stray marks or graffiti to the instrument, which could reduce the presentation quality of the instrument. In addition, the high-temperature coating can be arranged to manage transfers of heat between a thermal print head and the thermosensitive optical recording medium such that the number of life cycles of printing and erasing the thermosensitive optical recording medium are at least doubled over the number of life cycles without the high-temperature coating as measured against a common performance benchmark.

Preferably, the thermosensitive optical recording medium occupies a limited portion of the front face of the substrate, and the high-temperature coating covers not only the thermosensitive optical recording medium but also covers areas of the front face that are not occupied by the thermosensitive optical recording medium. The same or a different clear coating with an ink-repellant surface can be applied to the back face of the substrate to deter the adherence of stray marks or graffiti.

Another version of the invention as an optically and non-optically recordable instrument includes a substrate, an optical recording medium on the substrate, and a non-optical recording medium on the substrate. The optical recording medium is thermally rewritable. A high-temperature coating covers the optical recording medium and provides for the optical recording medium to be thermally imaged without producing speckle that would otherwise accompany such thermal imaging prior to the optical recording medium being thermally erased.

Preferably, the high-temperature coating treats an underlying unevenness to provide more uniform transfers of heat between a thermal print head and the optical recording medium. The high-temperature coating can be arranged to cover the optical recording medium without similarly covering the non-optical recording medium. The non-optical recording medium can comprise, for example, a magnetic strip. The high-temperature coating can also be arranged with an ink-repellant surface to deter the adherence of stray marks or graffiti over the optical recording medium or additionally to manage transfers of heat between a thermal print head and the optical recording medium such that the number of life cycles of printing and erasing the optical recording medium are at least doubled over the number of life cycles without the high-temperature coating as measured against a common performance benchmark.

Another version of the invention as an optical recording instrument with anti-graffiti protection includes a substrate having front and back faces and a thermosensitive optical recording medium on one of the front and back faces. A high-temperature coating applied over the thermosensitive optical recording medium has an ink-repellant surface to deter the adherence of stray marks or graffiti over the thermosensitive optical recording medium.

The same or a different clear coating with an ink-repellant surface can be applied to the back face of the substrate to deter the adherence of stray marks or graffiti. Where a non-optical recording medium, such as a magnetic strip, is carried on the back face of the substrate, the same or different coating is preferably applied in a limited zone to avoid application to the non-optical recording medium.

Another version of the invention as a thermally rewritable instrument with extended life cycles also includes a substrate having front and back faces and a thermosensitive optical recording medium on one of the front and back faces. A high-temperature coating applied over the thermosensitive optical recording medium manages transfers of heat between a thermal print head and the thermosensitive optical recording medium such that the number of life cycles of printing and erasing the thermosensitive optical recording medium are at least doubled over the number of life cycles without the high-temperature coating as measured against a common performance benchmark.

Yet another version of the invention as a method of initializing a thermally rewritable instrument includes steps of advancing a web having a substrate and a thermally rewritable layer on the substrate to a coating station and applying at the coating station a high-temperature coating over the thermally rewritable layer. The high-temperature coating is applied in a form that provides for more evenly conducting heat to the thermally rewritable layer from a thermal print head, so that the thermally rewritable layer can be thermally printed without producing speckle that would otherwise accompany such thermal printing prior to the thermally rewritable layer being thermally erased.

The step of applying preferably includes forming the high-temperature coating with an ink-repellant surface to deter the adherence of stray marks or graffiti over the thermally rewritable layer and can additionally or alternatively include arranging the high-temperature coating to manage transfers of heat between a thermal print head and the thermally rewritable layer such that the number of life cycles of printing and erasing the thermally rewritable layer are at least doubled over the number of life cycles without the high-temperature coating as measured against a common performance benchmark.

In addition to initializing the thermosensitive optical recording materials, extending the number of reprinting life cycles, and protecting against stray marks or graffiti, the topcoat can also reduce a coefficient of friction with the thermal print heads and reduce the tendency of rewritable instruments to cling to each other, which aids in the dispensing of individual rewritable instruments from a common stack.

### BRIEF DESCRIPTION OF THE DRAWING FIGURES

FIG. 1 is a front view of a negotiable card having a thermosensitive optical recording medium displaying updatable information.

FIG. 2 is a back view of the same negotiable card having a magnetically rewritable medium for recording information for machine identifying the card.

FIG. 3 is an enlarged cross-sectional view of the negotiable card taken along line 3-3 of FIGS. 1 and 2 depicting the layered structure of the card.

FIG. 4 depicts an initial image containing unwanted speckle produced in a conventional thermosensitive optical recording medium prior to being initialized by thermal erasing.

FIG. 5 depicts a corresponding initial image produced in a conventional thermosensitive optical recording medium covered by the high-temperature coating of the invention.

FIG. 6 is a schematic depiction of an in-line machine for applying optical and non-optical mediums to a web along with a high-temperature coating over the optical recording medium before the laminated web is cut into cards.

### DETAILED DESCRIPTION OF THE INVENTION

The first three drawing figures depict a negotiable card 10 of a type that can be used as a gaming machine ticket or voucher. The card 10 includes a substrate 12 having a front face 14 and a back face 16 that are variously printed with background graphic images 18 and 20. A thermosensitive optical recording medium 22, in the form of a thermally rewritable film, is centered on the front face 14 of the substrate 12. A non-optical recording medium 24, in the form of a magnetic strip, is laid out across the back face 16 of the substrate 12. Both the thermosensitive optical recording medium 22 and the non-optical recording medium 24 are preferably both reversible and rewritable for recording updatable information.

The thermosensitive optical recording medium 22 is based on thermochromic display technology in which a reversible change in color or opacity is produced by heating or heating and cooling. Bi-stable thermochromic compositions capable of producing reversible visible changes include dye complex systems that generally support changes in color and polymer-organic crystal systems that generally support changes in opacity.

In the dye complex systems, the visible changes are produced by thermally induced interactions or separations of a coloring agent and developer within a matrix. In the polymer-organic crystal systems, the visible changes are produced by thermally induced crystal size variations of a low-molecular-weight compound within a polymer matrix. Multi-color or multi-tone images can be produced by using multiple layers of thermochromic materials that have unique temperature profiles for varying between colored and decolored states. The color changing elements of both dye complex systems and polymer-organic crystal systems are generally embedded within a matrix and further embedded within a carrier material for application as a coating or film. The thermosensitive recording medium 22 can be assembled from multiple layers of thermochromic compositions, including supporting films, heat or light reflective layers, and a protective layer to protect the image recording layers from mechanical stress or damage.

One such thermochromic display technology appropriate for the thermosensitive optical recording medium 20 is based on a thermally rewritable film available from Ricoh Electronics Inc. of Santa Ana, Calif. under the trade name RECO-View®. Ricoh's PR film features white lettering against a silver background, and Ricoh's CR film features black lettering against a white or translucent background. Another potentially appropriate thermally rewritable film, which is sold under the trade name “Thermo Rewrite” by Mitsubishi Paper Mills Company Limited of Tokyo, Japan, is based on the use of leuco dyes for switching between colored and decolored states.

The substrate 12 can be made from a variety of materials that are capable of supporting the optical and non-optical mediums 22 and 24. For example, the substrate 12 can be made of paper or plastic materials, including synthetic paper or plastic film as well as laminates combining paper and plastic materials. The thermosensitive optical recording medium 22 can be applied to the substrate by printing or coating in the form of a solvent or colloidal suspension. The thermochromic components can also be microencapsulated within polymer shells that are dispersed in a binder or pre-hardened into a thin film that can be attached to the substrate 12 by lamination.

A high-temperature coating 26 designed to withstand the elevated temperatures required to switch thermochromic components between different color states is applied as a topcoat over the thermosensitive optical recording medium 22. Polymer-organic crystal systems typically require elevated temperatures of around 75° to 80° Celsius. Dye complex systems typically require higher elevated temperatures of around 100° C.

The high-temperature coating 26 is preferably made of a silicone resin but could also be formed from another thermoplastic or thermosetting resin. The resin compound can be dissolved in a solvent for applying to the substrate 12 and is preferably formulated for affinity to the front face 14 of the substrate to which it is applied. An intermediate or primer layer (not shown) can also be applied between the thermosensitive optical recording medium 22 and the high-temperature coating 26 to increase the adhesion between the thermosensitive optical recording medium 22 and the high-temperature coating 26.

Preferably, the high-temperature coating 26 is applied to the entire front face 14 of the substrate 12, which includes the areas of the front face 14 that extend beyond the area overlapped by the thermosensitive recording medium 22. In other words, the thermosensitive recording medium 22 occupies a limited portion of the front face 14, and the high-temperature coating 26 covers not only the recording medium 22 but also covers areas of the front face 14 that are not occupied by the recording medium 22.

Preferably, the high-temperature coating 26 has an ink-repellant surface to deter the adherence of stray marks or graffiti over the thermosensitive optical recording medium 22 or anywhere else on the front face 14 of the substrate 12. The same or a different clear coating 28 with an ink-repellant surface can be applied to the back face 16 of the substrate 12 to deter similar defacements of the card 10. However, the clear coating 28 is preferably not applied over the non-optical recording medium 24 to avoid interfering with the intended performance of the non-optical recording medium 24.

The addition of the high-temperature coating 26 has remarkable benefits for both the initial performance and the longevity of the thermosensitive optical recording medium 22. For example, the addition of the high-temperature coating 26 has the effect of initializing the thermosensitive optical recording medium 22 so that the thermosensitive optical recording medium 22 can be thermally printed without producing speckle that would otherwise accompany such thermal printing prior to the thermosensitive optical recording medium being thermally erased.

FIG. 4 shows an incompletely printed checkerboard pattern 30 in a conventional thermosensitive optical recording medium, corresponding to the optical recording medium 22, as printed by a conventional thermal print head 32 prior to the thermosensitive optical recording medium being initialized by at least one thermal erasing cycle. The printing is intended to form a pattern of black blocks, but the blocks 34, as printed, contain imperfections in the form of incompletely imaged specks 36.

FIG. 5 shows a more completely printed checkerboard pattern 40 in the thermosensitive optical recording medium 22 covered by the high-temperature coating 26. The checkerboard pattern 40 shows black blocks 44 printed by the same thermal print head 32 but without the imperfections of the checkerboard pattern 30 of the preceding figure. The high-temperature coating 26 is understood to treat an underlying unevenness within the thermosensitive optical recording medium 22 to provide more uniform transfers of heat between a thermal print head 32 and the thermosensitive optical recording medium 22.

The high-temperature coating 26 overlying the thermosensitive optical recording medium 22 also has the effect of significantly increasing the number of life cycles of acceptable printing and erasing that can be undergone by the thermosensitive optical recording medium 22. Life cycle increases by a factor of two or three are possible as measured against any significant loss in optical density. More consistent and uniform heat transfers between the thermal print head 32 and the thermosensitive optical recording medium 22 are credited with this remarkable result.

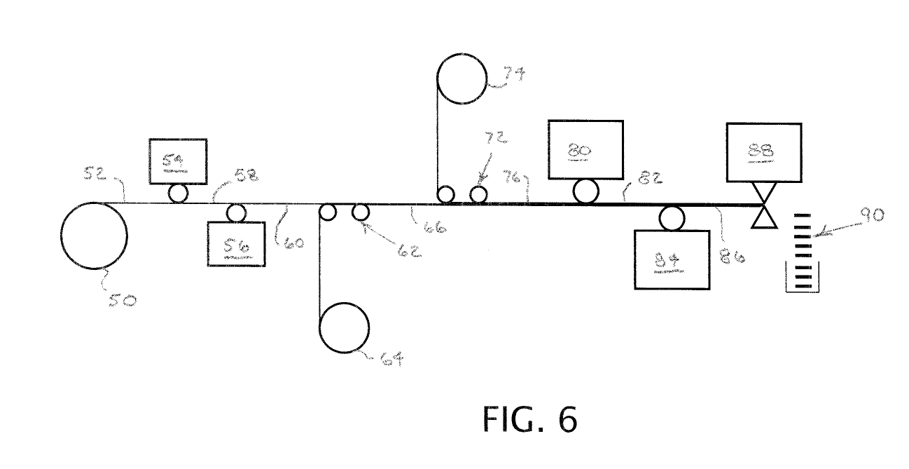

An inline process for making rewritable instruments such as the negotiable card 10 is shown in FIG. 6. A roll 50 of a base stock is unrolled and advanced in the form of a continuous web 52 through first and second print stations 54 and 56. The web 52 of base stock can be made of paper, plastic or a composite of the two for functioning as a substrate. The print stations 54 and 56 apply ink in desired patterns to form a series of graphic illustrations registered between a front side 58 and a back side 60 of the web 52.

A first laminating station 62 applies to the back side 60 of the web 52 from a supply roll 64 a non-optical recording medium in the form of a magnetic strip 66. A second laminating station 72 applies to the front side 58 of the web 52 from a supply roll 74 a thermosensitive optical recording medium in the form of a thermally rewritable film 76. The magnetic strip 66 can be applied continuously along the web 52. The thermally rewritable film 76, however, is preferably applied as patches registered to the graphic illustrations on the front side 58 of the web 52.

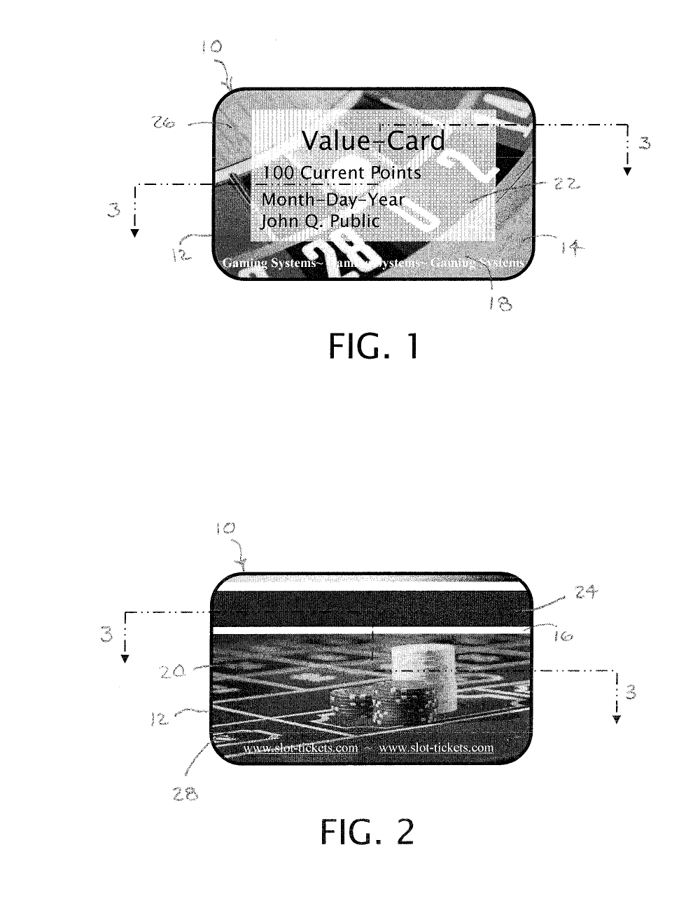

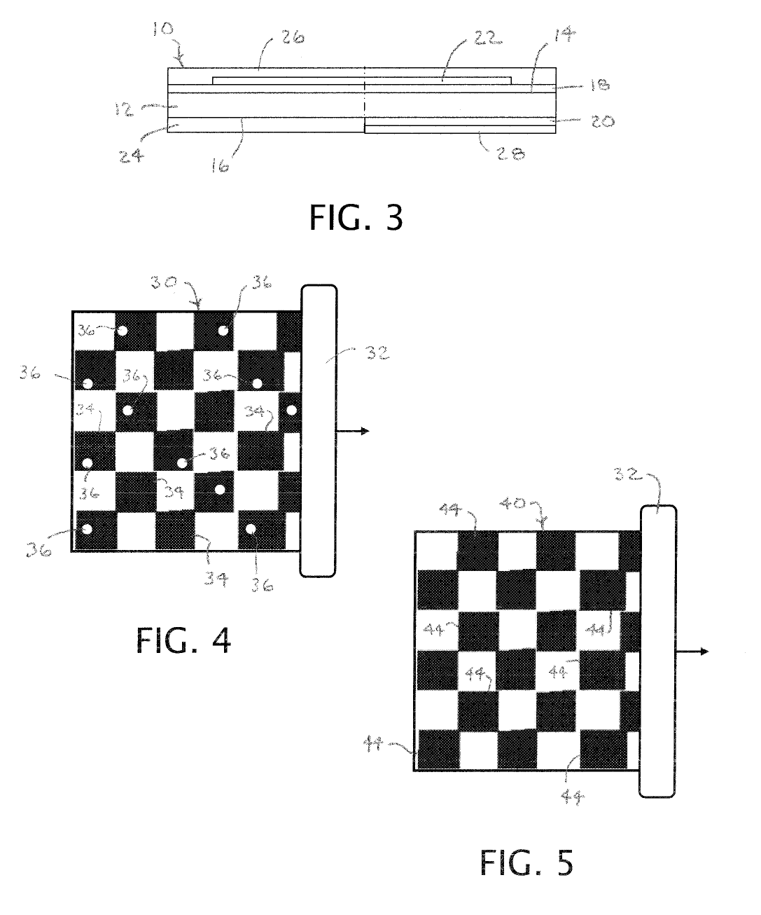

A first coating station 80 applies a high-temperature coating 82 to the front side 58 of the web 52 covering not only the thermally rewritable film but also the surrounding graphic illustrations on the front side 58 or the web 52. A second coating station 84 applies the same or similar clear coating 86 to the back side 60 of the web 52. However, the clear coating 86 is preferably applied to a limited zone of the back side 60 to avoid covering the magnetic strip 66. A die cutting station 88 cuts the laminated web 52 into a stack of cards 90, such as the negotiable card 10 of FIGS. 1-3.

Similar in-line processing can be used to make other thermally rewritable media in accordance with the invention including tags, tickets, and labels having a thermosensitive optical recording medium covered by a high-temperature coating.

1. A thermally rewritable instrument comprising
a substrate having front and back faces,
a thermosensitive optical recording medium on one of the front and back faces, and
a high-temperature coating applied over the thermosensitive optical recording medium providing for the instrument to be thermally printed within the thermosensitive optical recording medium without producing speckle that would otherwise accompany such thermal printing prior to the thermosensitive optical recording medium being thermally erased.

2. The instrument of claim 1 in which high-temperature coating treats an underlying unevenness to provide more uniform transfers of heat between a thermal print head and the thermosensitive optical recording medium.

3. The instrument of claim 1 in which the high-temperature coating has an ink-repellant surface to deter the adherence of stray marks or graffiti over the thermosensitive optical recording medium.

4. The instrument of claim 1 in which the high-temperature coating manages transfers of heat between a thermal print head and the thermosensitive optical recording medium such that the number of life cycles of printing and erasing the thermosensitive optical recording medium are at least doubled over the number of life cycles without the high-temperature coating as measured against a common performance benchmark.

5. The instrument of claim 1 in which the thermosensitive optical recording medium occupies a limited portion of the front face of the substrate, and the high-temperature coating covers not only the thermosensitive optical recording medium but also covers areas of the front face that are not occupied by the thermosensitive optical recording medium.

6. An optically and non-optically recordable instrument comprising
a substrate,
an optical recording medium on the substrate,
a non-optical recording medium on the substrate,
the optical recording medium being thermally rewritable, and
a high-temperature coating covering the optical recording medium and providing for the optical recording medium to be thermally imaged without producing speckle that would otherwise accompany such thermal imaging prior to the optical recording medium being thermally erased.

7. The instrument of claim 6 in which high-temperature coating treats an underlying unevenness to provide more uniform transfers of heat between a thermal print head and the optical recording medium.

8. The instrument of claim 6 in which the high-temperature coating covers the optical recording medium without similarly covering the non-optical recording medium.

9. The instrument of claim 8 in which the non-optical recording medium comprises a magnetic strip.

10. The instrument of claim 6 in which the high-temperature coating has an ink-repellant surface to deter the adherence of stray marks or graffiti over the optical recording medium.

11. The instrument of claim 6 in which the high-temperature coating manages transfers of heat between a thermal print head and the optical recording medium such that the number of life cycles of printing and erasing the optical recording medium are at least doubled over the number of life cycles without the high-temperature coating as measured against a common performance benchmark.

12. An optical recording instrument with anti-graffiti protection comprising
a substrate having front and back faces,
a thermosensitive optical recording medium on one of the front and back faces, and
a high-temperature coating applied over the thermosensitive optical recording medium having an ink-repellant surface to deter the adherence of stray marks or graffiti over the thermosensitive optical recording medium.

13. The instrument of claim 12 in which the thermosensitive optical recording medium occupies a limited portion of the front face of the substrate, and the high-temperature coating covers not only the thermosensitive optical recording medium but also covers areas of the front face that are not occupied by the thermosensitive optical recording medium.

14. The instrument of claim 13 in which a clear coating with an ink-repellant surface is applied to the back face of the substrate to deter the adherence of stray marks or graffiti.

15. The instrument of claim 14 in which the clear coating is made of the same material as the high-temperature coating.

16. The instrument of claim 14 further comprising a non-optical recording medium on the back face of the substrate, and the clear coating is preferably applied in a limited zone to avoid application to the non-optical recording medium.

17. The instrument of claim 16 in which the non-optical recording medium is a magnetic strip.

18. A thermally rewritable instrument with extended life cycles comprising
a substrate having front and back faces,
a thermosensitive optical recording medium on one of the front and back faces, and
a high-temperature coating applied over the thermosensitive optical recording medium that manages transfers of heat between a thermal print head and the thermosensitive optical recording medium such that the number of life cycles of printing and erasing the thermosensitive optical recording medium are at least doubled over the number of life cycles without the high-temperature coating as measured against a common performance benchmark.

19. A method of initializing a thermally rewritable instrument comprising steps of
advancing a web having a substrate and a thermally rewritable layer on the substrate to a coating station,
applying at the coating station a high-temperature coating over the thermally rewritable layer in a form that provides for more evenly conducting heat to the thermally rewritable layer from a thermal print head so that the thermally rewritable layer can be thermally printed without producing speckle that would otherwise accompany such thermal printing prior to the thermally rewritable layer being thermally erased.

20. The method of claim 19 in which the step of applying includes forming the high-temperature coating with an ink-repellant surface to deter the adherence of stray marks or graffiti over the thermally rewritable layer.

21. The method of claim 19 in which the step of applying includes arranging the high-temperature coating to manage transfers of heat between a thermal print head and the thermally rewritable layer such that the number of life cycles of printing and erasing the thermally rewritable layer are at least doubled over the number of life cycles without the high-temperature coating as measured against a common performance benchmark.

22. The method of claim 19 in which the thermally rewritable layer covers a limited portion of the substrate and the high-temperature coating covers not only the thermally rewritable layer but also covers areas of the substrate that are not occupied by the thermally rewritable layer.
